(19) United States
(12) Patent Application Publication
(10) Pub. No.: US 2006/0221403 A1
(43) Pub. Date: Oct. 5, 2006

(54) Device for printing an image on a large surface

(76) Inventor: Francois Bancel, Paris (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/543,071

(22) PCT Filed: Jan. 10, 2004
(86) PCT No.: PCT/FR04/50016

§ 371 Date: May 23, 2006

(30) Foreign Application Priority Data
Jan. 23, 2003 (FR) 0300870

(51) Int. Cl. H04N 1/40

(52) U.S. Cl. 358/3.24

(57) ABSTRACT

A device for printing an image on a large surface and that may be held and moved manually and is able to determine position and direction on a surface. The device uses this knowledge to determine which colors are to be applied on the surface. This determination is accomplished by matching the determined coordinates and an image stored in a memory of the device. The stored image may then be superimposed to the surface to be painted.

### FIELD OF THE INVENTION

This invention relates to a device for printing on a large surface. The field of the invention is that of the building and of the interior or exterior decorating trades. An object of the invention comprises the transfer of a large dimensions image onto a surface also of large dimensions. Another object of the invention comprises limiting the means that must be used to perform this transfer. Another object of the invention comprises allowing this transfer to be performed by a single operator. Another object of the invention comprises allowing the retouch/repair of a large dimensions image transferred on a surface also of large dimensions.

### BACKGROUND OF THE INVENTION

In the state of the art, different methods are known to transfer an image on a wall.

A first method involves employing a painter to paint the wall from an original pattern. This method is as time consuming and costly as the complexity of the image to be painted. In fact, if the image comprises many features, the painter must use brushes of sizes compatible with these features. It thus takes an extremely long time to cover a wall with paint with a fine brush.

A second method involves the industrial printing of the image on paper, followed by cutting the paper in strips. This way wallpaper is obtained that must later be stuck on the wall. This method has the usual drawbacks arising from the laying of wallpaper, i.e. the difficulties of the matching of the different wallpaper strips. Another drawback is related to the dimension differences between the walls. It is assumed that the length of the wallpaper strips and the way that must be used to print and cut them remains unknown. In addition with this method, the texture of the material on which the wallpaper is affixed is lost, meaning that the aspect of the image is altered and the desired visual impression is not obtained.

A third state of the art method involves using a very big plotter positioned in front of the wall on which the image is to be transferred. This device is very cumbersome and heavy. It is so bulky that its access into and thus its positioning in a room is sometimes impossible. Its operation by a single user is further impossible.

### SUMMARY OF THE INVENTION

According to the invention, some difficulties are solved by incorporating position determining, direction determining and printing means in a device operable with one hand. This device may take, for example, the external form of a paint roller in which the printing device has been substituted to the roller. The printing device comprises two wheels allowing the device to be moved on the surface while keeping a constant distance between the printing device and this surface. The device also comprises a position and direction determining device that allows a precise determination of its position on the surface on which an image is to be transferred. The knowledge of this position allows the reading by the device of a file defining an image to be transferred on the wall, the position on the wall being matched with a position in the image file. This file allows the determination of the printing requests to be sent to the printing heads of the device, according to its position. This file defines an image whose dimensions are matched with those of the wall. The position determination is made, for example, by the projection of a grill/grid on the wall. This grill is detected by an optical sensor of the device. At each crossing of the grill, a position data is attributed. The reading of this data allows the device to localize itself. The direction is obtained by using a second sensor giving a second position, by the use of a gyroscope, by the detection of the grill slope or by a move sensor of the optical mouse type that allows the moves of the device on the wall to be measured.

An operator thus performs the transfer of an image on a wall by moving the device according to the invention across the whole wall. According to an alternative embodiment, the device also comprises a memory allowing the parts of the wall already painted to be determined. Thus an accumulation of dye at some places is avoided. The need for the operator to be careful to evenly move the device on the surface is also avoided.

The invention accordingly relates to a device for printing an image on a large surface, the device comprising means for a dye transfer on said large surface, and at least one handling mean allowing an operator to handle the device to reproduce the image on the large surface, means to determine the device position on the large surface plane, and means to determine the device direction on the large surface plane, wherein the direction determining means and the position determining means cooperate with the dye transferring means to match the dye transfer with the device position and direction on said large surface.

### BRIEF DESCRIPTION OF THE DRAWINGS

The invention will be better understood while reading the following description in conjunction with the attached drawings. These are shown so as to be illustrative only and not limitative of the invention. In the drawings:

FIG. 1 generally shows a device according to the invention in a state of image transferring.

FIG. 2 shows a localizing grill according to the invention.

FIGS. 3a and 3b show a device according to the invention and components that the device comprises.

FIGS. 4a, 4b and 4c show embodiments of the localizing optical sensor according to the invention.

FIGS. 5a and 5b show an acoustical localizing according to the invention.

FIG. 6 shows several steps of a method of using the device according to the invention in order to transfer an image on a large surface.

### DETAILED DESCRIPTION OF THE INVENTION

In all the drawings, the same references indicate the same components.

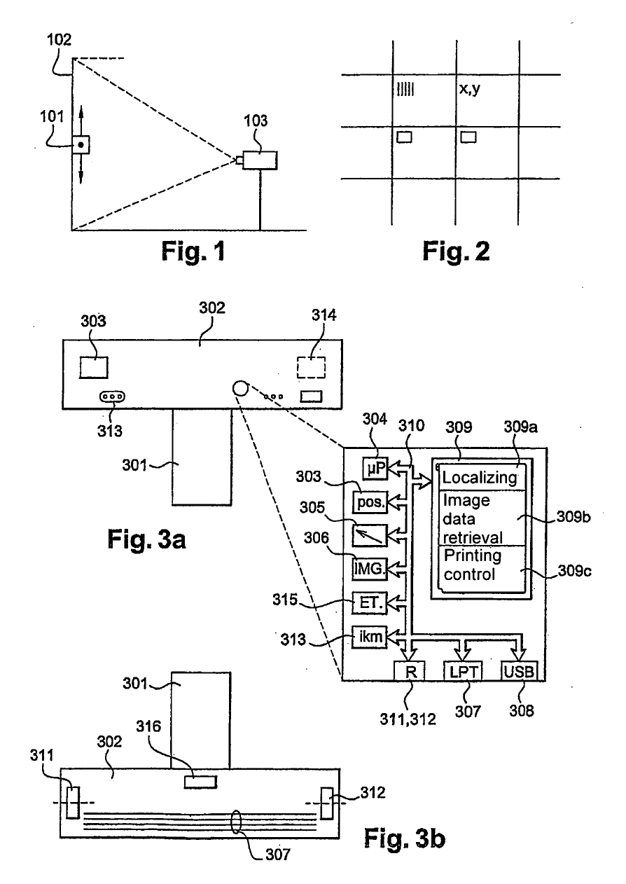

FIG. 1 shows a device 101 according to the invention, positioned near a wall 102 on which an image is to be transferred. The device 101 may be manually held and moved, like, for example, a paint roller. FIG. 1 does not show the operator that uses the device 101, for the sake of clarity of illustration. FIG. 1 also shows a projector 103 positioned in front of the wall 102. The projector 103 is thus comprised in an alternative embodiment of the invention allowing the device 101 to localize itself on the wall 102. To this end, the projector 103 projects on the wall a grid or grill allowing the wall 102 to be attributed a coordinate system that may be read by the device 101.

FIG. 2 shows an exemplary grill projected by the projector 103. This grill is a grid comprising, for example, horizontal and vertical lines. The direction of the lines need not be horizontal or vertical; these lines may be inclined and define a non-orthogonal lines network. FIG. 2 also shows that at each crossing of two lines a coordinate data is allocated. This data is, for example, a barcode or an abscissa/ordinate couple. This data is read by the device 101 to obtain a position determination on the wall 102. The grill lines are typically very thin, less than 0.1″ in width, and are spaced on the wall at distances from 2 inches to a few tens of inches. The coordinate data of a crossing are always placed at the position relative to the crossing. This allows a crossing and its coordinates data to be associated.

FIG. 3a shows a bottom view of a device 101 according to the invention. The device of FIG. 3a is the same as the device illustrated in FIG. 1; other alternative embodiments of the device 101 will be devised below. The device 101 has the shape of a painter roller. The device 101 comprises a handle 301 that allows grasping and handling of the device 101. The device 101 also comprises a body 302 that is fixed to the handle 301 and extends in a direction perpendicular to the handle 301. The top of the device 101 the part viewed by an operator when the device 101 is placed against the wall 102 in operation. The bottom is the part of the device 101 that is then facing the wall 102.

On its upper side, the body 302 comprises an optical sensor 303 that reads the data projected by the projector 103. FIG. 3a also shows that the body 302 comprises a microprocessor 304, a direction sensor 305, an image memory 306, printing means 307, means 308 to communicate with an external device, and a program memory 309. The components 303-309 are connected via a bus 310. When a function is requested of the device 101, this function is executed by the microprocessor 304 controlled by instruction codes from the memory 309.

The memory 309 comprises several areas, each of these areas corresponding to instruction codes allowing the execution of a function by the device 101. The memory 309 comprises an area 309a corresponding to the position determination of the device 101. An area 309b contains instruction codes to retrieve image data written in memory 306. An area 309c contains instruction codes to control the printing means 307.

FIG. 3b shows a bottom view of the device 101. At each end of the body 302, the device 101 has a wheel. The wheels 311 and 312 are fixed on axles extending in a direction perpendicular to the wall 102 plane and perpendicular to the handle 301. The wheels 311 and 312 each comprise a pressure sensor connected to bus 310. These pressure sensors act like switches for the operation of the printing means 307. The printing means are, for example, an ink jet device. This device thus comprises four nozzle lines, three color lines and one black line. These four lines are parallel and near each other. At least one nozzle of each line is needed to print a dot in any visible color. The whole of these four lines form an ink jet printing head. This printing head may be considered a series of points. The nozzles must project ink only when at an adequate distance from the surface to be colored. This distance is sensed for example through the wheels 311 and 312. When the latter are in contact with this surface, this surface applies a pressure on the wheels and this pressure is detected by the device 101 that thus knows that it may activate the nozzles. In an alternative embodiment, this activation is done by the operator that operates a button of a user/device interface 313 connected to bus 310.

In an alternative embodiment, the body 302 comprises a third wheel 317 whose rotational axis is parallel to the rotational axis of the wheels 311 and 312, but not collinear with this axis. In other words, the wheel 317 is not in alignment with the wheels 311 and 312. The third wheel 317 also incorporates a pressure sensor. Using three wheels allows to define a plane and to maintain a precise distance between the wall 102 and the printing means 307. The third wheel is offset in the direction of the handle 301 relative to the axis of wheels 311 and 312. Preferably, the printing means 307 are offset relative to the wheels 311 and 312 axis, this offset being in a direction opposed to the direction in which the handle 301 is placed. This relative positioning of the printing means 307 allows limiting the unprintable margins.

The nozzle distribution on four lines is but an example. In practice, this distribution depends on the printing head used. Particularly, the color distribution will vary from one manufacturer to another. Multicolor printing heads, on which the color distribution, i.e. the nozzle distribution, is particular or single color printing heads distributed in lines or in squares may be used.

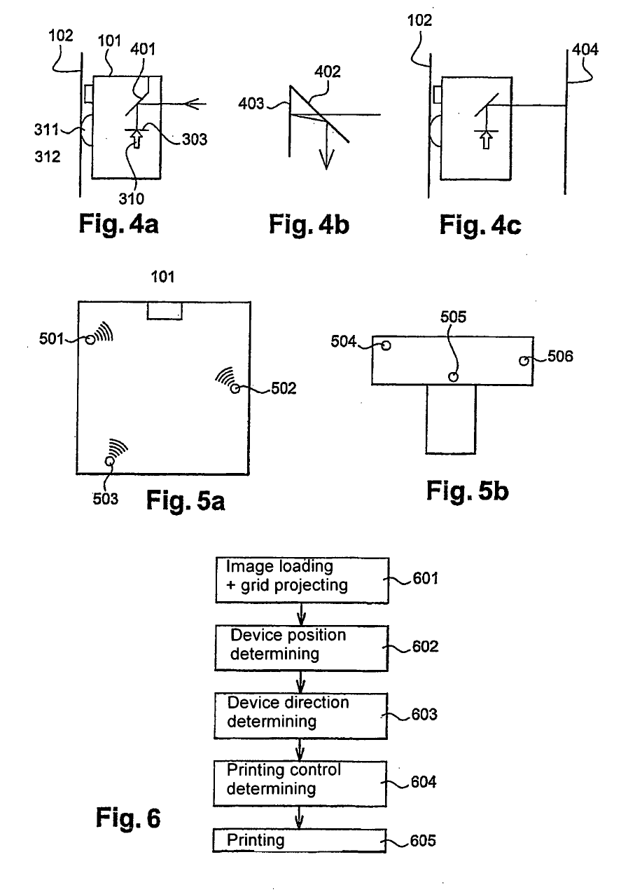

The sensor 303 is a CCD sensor, or charge coupled device, responsive to light, receiving the image projected by the projector 103. This CCD sensor has a resolution of at least 0.01 inch and, preferably, such a definition that it always has in its field of view at least one crossing of the grid projected by the projector 103. In practice, the sensor definition allows obtainment of a square image of dimensions slightly larger than the grid pitch. The CCD sensor may be located directly on the path of the light rays transmitted by the projector 103, eventually through a lens. The light rays may also be deflected to the CCD sensor via a mirror or a prism. FIG. 4a shows a device 101 whose wheels 311 and 312 are in contact with the surface 102. FIG. 4a illustrates the fact that a mirror 401 receives the light rays transmitted by the projector 103 and reflects them to a CCD sensor. FIG. 4b shows an alternative embodiment in which the light rays pass through a semi-reflective mirror 402, are reflected by a mirror 403 and then reflected by the mirror 402 to the CCD sensor. Again, the grid is superimposed, by optical projection, on the surface to be painted. In an alternative embodiment, the sensor 303 receives the grid projection on a screen. This alternative embodiment is thus, for example, the embodiment of FIG. 4b in which a screen, preferably white, is substituted to the vertical mirror 403. According to another embodiment, the sensor 303 is positioned directly in front of the projector 103.

The sensor 303 is thus able to perform a localizing image acquisition, this image containing a grid part and a localizing data attributed to a crossing of this grid part. By this localizing image, the device 101 is able to localize on the surface 102. In an alternative embodiment, the sensor 303 does not always have a crossing in its field of acquisition. According to this embodiment, between two readings made on crossings, the sensor measures the relative displacement of the background grid with the help of the grid features that it perceives. To this end, flaws may be added to the grid, allowing measuring the relative displacement of said grid. This relative displacement of the grid relative to the sensor 303, thus to the device 101, may also be estimated by a sensor detecting the wall 102 and its flaws.

The device direction determining means 305, relative to the wall, are embodied by an optical or mechanical gyroscope. An optical gyroscope is obtained, for example, by analyzing the image acquired by the sensor 303 and by determining the angle formed between a grid line and an edge of this image acquired by the sensor 303. An optical gyroscope may also be acquired by providing the device 101 with a second sensor 314 identical to the sensor 303. The device 101 is thus able to define the line joining these two sensors at the localizing image acquisition instant date and consequently to direct itself at this instant. A mechanical gyroscope is embodied by any device producing a signal allowing estimating a deflection relative to the vertical direction.

Connector 308 allows connecting the device 101 to other apparatuses. The connector 308 may be, for example, an USB port, a Fire Wire port, a Blue Tooth connector or any other connector type, either of the wired or wireless type.

FIG. 6 shows an operation step series of the device 101 according to the invention. FIG. 6 shows a step 601 preceding the loading of an image and the projection of the grid. The grid projection is performed first by correctly positioning the projector 103 relatively to the wall 102. This positioning is performed, if needed, with the help of micrometer screws. The positioning is correct when the projected grid covers the surface to be painted. The loading of the image in memory 306 is performed via connector 308. The image depicts the picture to be transferred on the wall 102. The dimensions of the image to be transferred are matched with the wall 102 dimensions and the printing resolution. The printing resolution is expressed, for example, in dots per inch (DPI). This resolution is a function of the printing heads 307. The dimension in pixels of the image stored in memory 306 is thus obtained by multiplying the wall dimensions by the printing resolution. Either memory 306 contains the whole image, or the device 101 is continually connected to a third device storing the image, the device 101 having access at will to this third device via connector 308. A third device may be, for example, an external hard disk or a laptop computer.

From step 601, the control goes to step 602 to determine the device 101 position. This position is determined by the device 101 interpretation of the image acquired by the sensor 303. As soon as the image to be transferred is loaded, an operator may hold the device 101 in place against the wall 102 and begin the image transfer or image printing.

From step 602, the control goes to step 603 to determine the device 101 direction. This direction determination is obtained by the interpretation of the signals produced by the means 305.

From step 603, the control goes to step 604 to determine the printing controls, i.e. to determine the controls to be sent to printing means 307. In an alternative embodiment, the apparatus stores in a memory 315, while the printing proceeds, an image rendering the printing progression state. The content of memory 315 relates to what has already been printed. At step 604, the device 101 knows its coordinates and its direction. The device uses this knowledge to read out of memory 306 the color data to be used to control the printing means 307. The memory 306 image is formed such that it may be superimposed on the surface to be printed. The knowledge of the coordinates on the surface to be printed thus corresponds to the knowledge of the coordinates on the image stored in memory 306. To most efficiently determine the printing controls, the device 101 must also be able to recall the already printed pixels. Thus, each time the device 101 prints a pixel, it updates the memory 315 content. This update involves transferring the image to be printed into memory 315, while this image is being printed on the wall 102.

At step 604, as soon as the device 101 has read the memory 306 content corresponding to its position, the device reads the memory 315 content corresponding to its position and then the device compares the two readings results. The result of a reading, assuming the device has a linear printing head, is the description of a pixel line, i.e. the description of a color for each pixel. When a pixel is marked in memory 315 as already printed, it does not have to be printed again. The description of this pixel then becomes transparent. The device 101 thus executes a substraction between the first reading result and the second reading result. The subtraction result is a line description in which the already printed pixels are attributed a transparent color. The result of this subtraction is the printing control. Step 604 involves a data reading out of memory 306.

From step 604, the control goes to a printing step 605 in which the device 101 uses the printing control determined at step 609 in order to control the printing means 307. At each pixel corresponds a definite number of nozzles. These nozzles are activated according to the color to be produced. For a transparent pixel, no ink is projected. At step 605, the device 101 also updates the memory 315 contents.

Steps 602 to 605 are repeated in cycles, either at a constant frequency or each time the device 101 detects a move. This detection is accomplished either through the wheels moves or via a sensor 316 connected to bus 310 and mounted at the bottom of the device 101 in front of the wall 102 or directly by the sensor 303. The sensor 316 is consequently of the type that equips an optical mouse and is able to provide a direction and a move distance.

The repeating of steps 602 to steps 605 allows transfer of the image from memory 306 to the wall 102, by way of a printing being done while the device 101 moves across the whole wall 102 surface.

The dye transfer means 307 are provided in this alternative embodiment by an ink jet printing head comprising nozzles in alignment along at least 4 lines. In other alternative embodiments, these means may be provided by printing heads projecting paint or another chemical matter able to alter the appearance of the surface on which the image stored in memory 306 is to be transferred.

According to an alternative embodiment, a panel on which a grill like the grill described in FIG. 2 is substituted for the projector 103. FIG. 4c shows such a panel 404 positioned parallel to the wall 102. The panel is thus perceived by the sensor 303. In this case, the sensor 303 is localized on the panel. The panel 404 is placed at a distance from the wall 102 such that there is enough room for an operator to handle the device 101 between the panel and the wall. The device 101 position and direction determinations are then accomplished relative to the panel.

According to an alternative embodiment of the invention, the projector 103 projects the image to be transferred on the wall 102. In this case, the device 101 comprises a sensor that allows perceiving this projected image and the result of this perception actually allows determining the colors to be printed according to the device 101 position.

According to an alternative embodiment, the position determination is obtained by printing marks invisible to the naked eye. The device thus comprises a scanner that perceives these marks around the printing zone. These marks are applied by the device 101 while the printing proceeds, using ink invisible except to the scanner. When needed this scanner may illuminate the zone with an adequate light. The device 101 may thus superimpose marks invisible to the naked eye to the image that it is printing. By a step-by-step scanning, the apparatus knows all the time its position by mean of the marks printed at a preceding and adjacent pass. At the beginning of this operation, the marking is initiated by a printed sheet glued on the wall. This sheet bears marks invisible except to the scanner. The position of this sheet in the image to be printed is known. The printing may thus begin on this sheet and from there on the rest of the wall. At the end of the operation, the sheet is removed and the device 101 is moved across the surface left in order to paint this area.

According to an alternative embodiment, the position and direction determinations are accomplished by ultrasonic means. Thus, providing three transmitters (501-503) at definite positions in the room and two receivers on the device 101 is only needed. The device 101 is then able to determine its distance from the three transmitters and consequently, by triangulation, to determine its position. According to this embodiment, only one transmitter may also be used by providing the device 101 with three receivers (504-506). According to this embodiment, means to store the transmitter(s) position in memory are needed in order to be able to place them anew at the same place(s) to execute maintenance of the picture. This storage in memory may be accomplished with a nail set at a precise place, for example. These embodiments assume that the device 101 knows the ultrasound transmitting instant dates. These dates are communicated via means 308, for example.

According to an alternative embodiment of the invention, the position determination is accomplished by mean of a laser scanning the wall surface. This laser is detected at a t instant by the device 101. This t instant is matched to a known laser position. This position is obtained by sending a request to the laser-transmitting device, via means 308, for example. The laser may also draw on the wall 102 a grid like the grid shown FIG. 2.

According to an alternative, the direction is determined by mean of sensor 316 that is able to measure a move relatively to a known position. From a known initial position, the already realized move and consequently the current position and direction may thus be estimated.

With the device according to the invention, several layers of paint may be applied. To this end, only clearing of the memory 315 contents is needed, and the printing operation is resumed as if it actually never began before.

With the device according to the invention, repainting/repairing a definite zone of the wall is also possible. To this end, the device 101 must be repositioned on the image transferred on the wall 102. This repositioning is done via physical marks, like the wall corners that allow repositioning the grill projected by projector 103. The correct grill repositioning is thus enough to reposition the device 101. The repositioning may also be accomplished by shape recognition on high contrast zones. In that case, the device 101 comprises a scanner that reads a zone of the printed image. Then, the device looks in the memory 306 image for the zone corresponding to the scanned zone. Once the zone found, the repositioning is executed. When the device 101 comprises a scanner, the latter may be used to acquire an image. This acquisition is realized by moving the device 101 above the image whose acquisition is desired. This acquired image is then stored, for example, in memory 306. This acquired image may later be transferred on another wall or to a third device via means 308.

While the painting proceeds, the projector 103 may accidentally be knocked and moved. In this case, the projector must be repositioned. To this end, the projector 103 may comprise a collision sensor that allows warning the operator when a grid repositioning must be accomplished. In that case, the repositioning is the same as the above described repositioning.

The operator/apparatus interface 313 is located either on the operator body or on the handle. The interface comprises, for example, on/off buttons, a memory 315 reset button, a button and to override the printing regardless of memory 315 contents. This interface also comprises light diodes and/or acoustic means that warn the operator of definite events like a device moving too fast on the wall, a low ink supply level, or a grill move. The speed of the moving device 101 is easily estimated through wheels 311, 312 and 317 rotational speed, sensor 316, or sensor 303. These wheels and sensors also give access to a device 101 acceleration. Thus, when these events are detected, the printing may also be interrupted in order to avoid flaws in the image transfer if means 307 are not able to accomplish the printing in a manner compatible with the speed of the moving device 101. The printing is also interrupted if the operator is placed between sensor 303 and the grid.

The dye tanks containing inks, paints or other fluids, are either incorporated in to the device 101 or remotely provided elsewhere. The dye supply is then realized through pipes joining the tanks to the device according to the invention.

The data computing and reading may also be remotely executed, like memories 306 and 315, on a third apparatus connected to the device 101.

An image transfer on a vertical wall has been described, but the teachings of the invention may also be applied whatever the surface and its direction are.

In practice, the wall may not have a perfect rectangular shape. In this case, either the image is cut in order to take the actual shape into account or the device 101 is consequently configured. This configuring is realized, for example, by positioning the device 101 at the angles of the zone on which the image is to be transferred. At each angle positioning, the operator pushes a button, thus allowing the device 101 to define the printing zone. This zone is located in the polygon defined by these angles and the printing is activated only when the device 101 position is determined to be inside this polygon.

In an alternative embodiment, the device according to the invention is operated by a robot that moves the device across the wall.

1. A device adapted to print an image on a large surface, the device comprising:
dye transferring means for transferring a dye on a large surface;
at least one handling means for allowing an operator to handle the device to reproduce an image on the large surface;
position determining means for determining a position of the device on a plane of the large surface;
direction determining means for determining a direction of the device on the plane of the large surface; and
projecting means for projecting a coordinate system; wherein the direction determining means, the position determining means, and the projecting means cooperate with the dye transferring means to match the dye transfer with the device position and direction on the large surface.

2. The device of claim 1, wherein the position determining means comprise an optical sensor adapted to read a grill covering the large surface.

3. The device of claim 2, wherein each grill crossing is associated with position data read by the sensor.

4. The device of claim 1, wherein the position determining means comprise an optical sensor adapted to read position data on the large surface.

5. The device of claim 1, wherein the position and direction determining means comprise localizing means, and wherein the localizing means comprise an ultrasonic receiver.

6. The device of claim 1, wherein the direction determining means comprise a gyroscope.

7. The device of claim 1, wherein the direction determining means comprise a sensor adapated to estimate the path already taken by the device moving on the large surface.

8. The device of claim 1, further comprising a memory adapted to store an image to be transferred on the large surface.

9. The device of claim 1, wherein the dye transferring means comprise an ink jet device.

10. The device of claim 1, wherein the dye transferring means comprise a paint jet device.
